(19) United States
(12) Patent Application Publication
(10) Pub. No.: US 2026/0122586 A1
(43) Pub. Date: Apr. 30, 2026

(54) SYNCHRONIZATION RASTER CONFIGURATION

(71) Applicant: QUALCOMM Incorporated, San Diego, CA (US)

(72) Inventors: Yongle WU, San Diego, CA (US); Rahul MALIK, San Diego, CA (US); Carl HARDIN, Encinitas, CA (US)

(21) Appl. No.: 18/932,979

(22) Filed: Oct. 31, 2024

(51) Int. Cl. H04W 56/00; H04W 48/16

(52) U.S. Cl. CPC H04W 56/001; H04W 48/16

(57) ABSTRACT

Various aspects of the present disclosure generally relate to wireless communication. In some aspects, a user equipment (UE) may receive, from a network node, a synchronization raster configuration indicating that a first layer of each component carrier of a plurality of component carriers associated with a wireless-backhaul-over-cable configuration is to be used as a reference layer for a cell acquisition synchronization raster. The UE may communicate with the network node using the wireless-backhaul-over-cable configuration and in accordance with the synchronization raster configuration. Numerous other aspects are described.

### FIELD OF THE DISCLOSURE

Aspects of the present disclosure generally relate to wireless communication and specifically relate to techniques, apparatuses, and methods associated with synchronization raster configuration.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving, from a network node, a synchronization raster configuration indicating that a first layer of each component carrier of a plurality of component carriers associated with a wireless-backhaul-over-cable configuration is to be used as a reference layer for a cell acquisition synchronization raster. The method may include communicating with the network node using the wireless-backhaul-over-cable configuration and in accordance with the synchronization raster configuration.

Some aspects described herein relate to a method of wireless communication performed by a network node. The method may include transmitting, to a UE, a synchronization raster configuration indicating that a first layer of each component carrier of a plurality of component carriers associated with a wireless-backhaul-over-cable configuration is to be used as a reference layer for a cell acquisition synchronization raster. The method may include communicating with the UE using the wireless-backhaul-over-cable configuration and in accordance with the synchronization raster configuration.

Some aspects described herein relate to an apparatus for wireless communication at a UE. The apparatus may include one or more memories and one or more processors coupled to the one or more memories. The one or more processors may be configured to receive, from a network node, a synchronization raster configuration indicating that a first layer of each component carrier of a plurality of component carriers associated with a wireless-backhaul-over-cable configuration is to be used as a reference layer for a cell acquisition synchronization raster. The one or more processors may be configured to communicate with the network node using the wireless-backhaul-over-cable configuration and in accordance with the synchronization raster configuration.

Some aspects described herein relate to an apparatus for wireless communication at a network node. The apparatus may include one or more memories and one or more processors coupled to the one or more memories. The one or more processors may be configured to transmit, to a UE, a synchronization raster configuration indicating that a first layer of each component carrier of a plurality of component carriers associated with a wireless-backhaul-over-cable configuration is to be used as a reference layer for a cell acquisition synchronization raster. The one or more processors may be configured to communicate with the UE using the wireless-backhaul-over-cable configuration and in accordance with the synchronization raster configuration.

Some aspects described herein relate to a non-transitory computer-readable medium that stores a set of instructions for wireless communication by a UE. The set of instructions, when executed by one or more processors of the UE, may cause the UE to receive, from a network node, a synchronization raster configuration indicating that a first layer of each component carrier of a plurality of component carriers associated with a wireless-backhaul-over-cable configuration is to be used as a reference layer for a cell acquisition synchronization raster. The set of instructions, when executed by one or more processors of the UE, may cause the UE to communicate with the network node using the wireless-backhaul-over-cable configuration and in accordance with the synchronization raster configuration.

Some aspects described herein relate to a non-transitory computer-readable medium that stores a set of instructions for wireless communication by a network node. The set of instructions, when executed by one or more processors of the network node, may cause the network node to transmit, to a UE, a synchronization raster configuration indicating that a first layer of each component carrier of a plurality of component carriers associated with a wireless-backhaul-over-cable configuration is to be used as a reference layer for a cell acquisition synchronization raster. The set of instructions, when executed by one or more processors of the network node, may cause the network node to communicate with the UE using the wireless-backhaul-over-cable configuration and in accordance with the synchronization raster configuration.

Some aspects described herein relate to an apparatus for wireless communication. The apparatus may include means for receiving, from a network node, a synchronization raster configuration indicating that a first layer of each component carrier of a plurality of component carriers associated with a wireless-backhaul-over-cable configuration is to be used as a reference layer for a cell acquisition synchronization raster. The apparatus may include means for communicating with the network node using the wireless-backhaul-over-cable configuration and in accordance with the synchronization raster configuration.

Some aspects described herein relate to an apparatus for wireless communication. The apparatus may include means for transmitting, to a UE, a synchronization raster configuration indicating that a first layer of each component carrier of a plurality of component carriers associated with a wireless-backhaul-over-cable configuration is to be used as a reference layer for a cell acquisition synchronization raster. The apparatus may include means for communicating with the UE using the wireless-backhaul-over-cable configuration and in accordance with the synchronization raster configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of synchronization raster configuration, in accordance with the present disclosure.

FIG. 4 is a diagram illustrating an example of spectrum allocation for synchronization raster configurations, in accordance with the present disclosure.

FIG. 5 is a diagram illustrating an example of a synchronization raster configuration using component-carrier-first mapping, in accordance with the present disclosure.

FIG. 6 is a diagram illustrating an example of a synchronization raster configuration using layer-first mapping, in accordance with the present disclosure.

FIG. 7 is a diagram illustrating an example process performed, for example, at a user equipment or an apparatus of a user equipment, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Wireless-backhaul-over-cable is a technology for providing cellular network data services over a cable infrastructure. One example type of wireless-backhaul-over-cable technology is 5G New Radio (NR) over coax (NRoC). NROC utilizes 5G NR technology, originally designed for wireless channels utilizing multiple input multiple output (MIMO) techniques, to achieve high-throughput data transmissions over cable networks. However, since cable infrastructures are inherently single input single output (SISO), the multiple MIMO layers used in wireless 5G NR networks may need to be frequency division multiplexed (FDM) to adapt to the single-channel nature of the cable network. By transforming MIMO into an FDM-compatible format at the transmitter and reversing the process at the receiver, NROC can adapt the high-capacity envelope of 5G NR to cable environments, aiming to match the throughput performance of wireless 5G networks in a wired setting.

A synchronization raster is a timing mechanism that aligns data transmissions across different network components, such as network nodes and mobile devices. Synchronization rasters may set reference points to improve a likelihood that data packets are synchronized between transmitters and receivers, thereby minimizing data loss, delay, and signal distortion. By coordinating frame and signal timing, synchronization rasters can maintain seamless communication and stable connections, particularly in systems with high data demands such as 5G NR. In the context of

NRoC, a synchronization raster can provide a grid or sequence of reference signals that enable devices to detect and synchronize with transmission signals. However, existing synchronization rasters used in 5G NR, designed specifically for wireless environments, may not be able to be directly applied to cable-based transmissions. For example, wireless synchronization rasters depend on characteristics unique to wireless channels, such as spatial diversity and multipath propagation, which are absent in cable networks. Consequently, using these wireless-oriented rasters in NROC can lead to inefficient synchronization, reduced throughput, and increased latency.

Various aspects relate generally to wireless communications. Some aspects more specifically relate to synchronization raster configurations for wireless-backhaul-over-cable communications. A UE may receive a synchronization raster configuration indicating that a first layer (L0) of each component carrier (CC) of a plurality of component carriers associated with the wireless-backhaul-over-cable configuration is to be used as a reference layer for cell acquisition. For example, the UE may receive a synchronization raster configuration that includes a clustering scheme associated with a frequency domain resource allocation for a cell acquisition process. The clustering scheme may indicate multiple clusters, where each cluster of the multiple clusters includes multiple chunks. The chunks may be spaced apart in accordance with a first value and the clusters may be spaced apart in accordance with a second value that is larger than the first value. A synchronization signal block (SSB) for the cell acquisition process may only be received within the first layer of the component carriers and may not be received within any other layer of the component carriers. In some aspects, the synchronization raster configuration includes a component-carrier-based mapping. The component-carrier-based mapping may indicate that each cluster is to be associated with a different component carrier and that multiple layers associated with each component carrier are to be arranged contiguously in each cluster of the multiple clusters. In one example, the first layer of each component carrier of the multiple component carriers is included in a first chunk of a corresponding cluster associated with the component carrier. In another example, the first layer of each component carrier of the multiple component carriers is included in a last chunk of the corresponding cluster associated with the component carrier. In some other aspects, the synchronization raster configuration may include a layer-based mapping. The layer-based mapping may indicate that each cluster is to include a same layer associated with the multiple component carriers and that the multiple component carriers are to be arranged contiguously in each cluster of the multiple clusters. On one example, the first layer of each component carrier of the multiple component carriers may be included in a first cluster of the multiple clusters. In another example, the first layer of each component carrier of the multiple component carriers is included in a last cluster of the multiple clusters. The UE may communicate with a network node using the wireless-backhaul-over-cable configuration and in accordance with the synchronization raster configuration. For example, the UE may perform a cell acquisition process using the first layer (L0) of each component carrier of the multiple component carriers associated with the wireless-backhaul-over-cable configuration, where the cell acquisition process includes receiving one or more synchronization signal blocks using the first layer of each component carrier.

Particular aspects of the subject matter described in this disclosure can be implemented to realize one or more of the following potential advantages. In some examples, by enabling a first layer of each component carrier of multiple component carriers associated with a wireless-backhaul-over-cable configuration to be used as a reference layer for cell acquisition synchronization, the described techniques can be used to improve wireless-backhaul-over-cable communications, such as NRoC communications between a UE and a network node. In some examples, by enabling the UE and the network node to communicate using the wireless-backhaul-over-cable configuration and in accordance with the synchronization raster configuration, the described techniques can be used to improve synchronization processes between the UE and the network node. In some examples, by enabling the UE and the network node to communicate using the wireless-backhaul-over-cable configuration and in accordance with the synchronization raster configuration, the described techniques can be used to increase throughput in the wireless-backhaul-over-cable communications. In some examples, by enabling the UE and the network node to communicate using the wireless-backhaul-over-cable configuration and in accordance with the synchronization raster configuration, the described techniques can be used to reduce latency in the wireless-backhaul-over-cable communications. These example advantages, among others, are described in more detail below.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

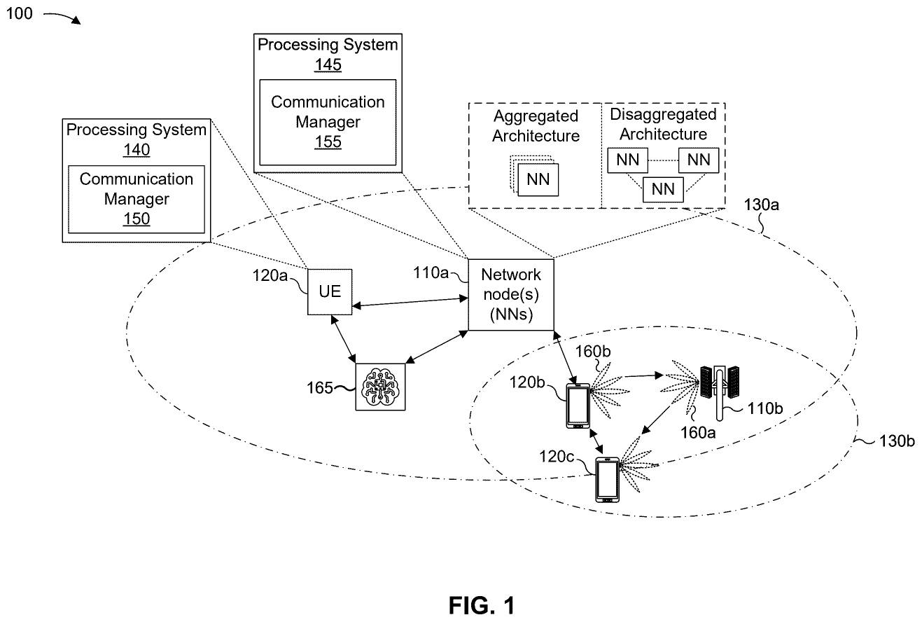

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FRI is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FRI, and/or that are included in mid-band frequencies. Similarly, the term “millimeter wave,” if used herein, may broadly refer to mid-band frequencies or to frequencies that arc within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

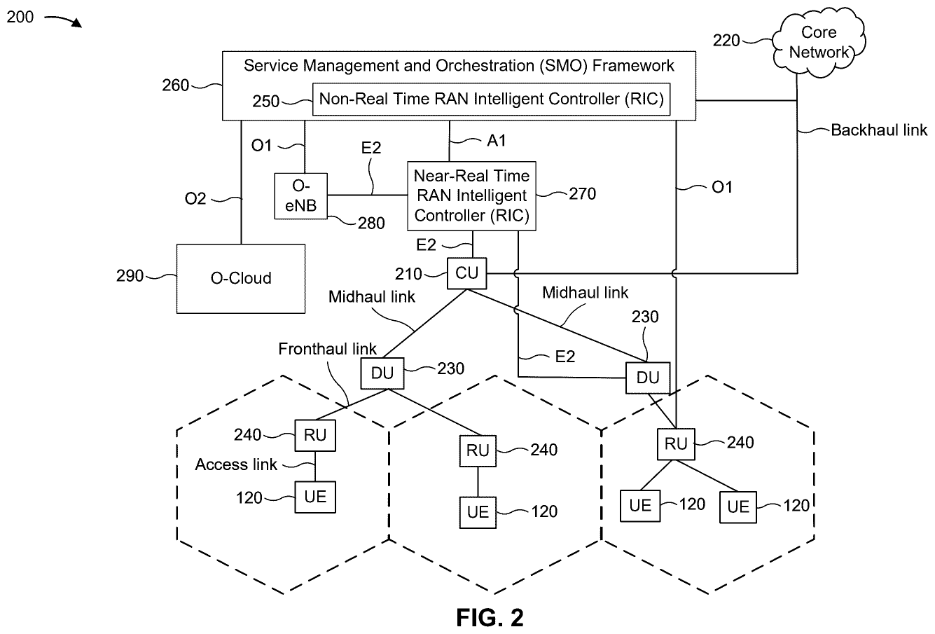

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IOT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a

UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (LI)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, from a network node, a synchronization raster configuration indicating that a first layer of each component carrier of a plurality of component carriers associated with a wireless-backhaul-over-cable configuration is to be used as a reference layer for a cell acquisition synchronization raster; and communicate with the network node using the wireless-backhaul-over-cable configuration and in accordance with the synchronization raster configuration. Additionally, or alternatively, the communication manager 150 may perform one or more other operations described herein.

In some aspects, the network node 110 may include a communication manager 155. As described in more detail elsewhere herein, the communication manager 155 may transmit, to a UE, a synchronization raster configuration indicating that a first layer of each component carrier of a plurality of component carriers associated with a wireless-backhaul-over-cable configuration is to be used as a reference layer for a cell acquisition synchronization raster; and communicate with the UE using the wireless-backhaul-over-cable configuration and in accordance with the synchronization raster configuration. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the El interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-cNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

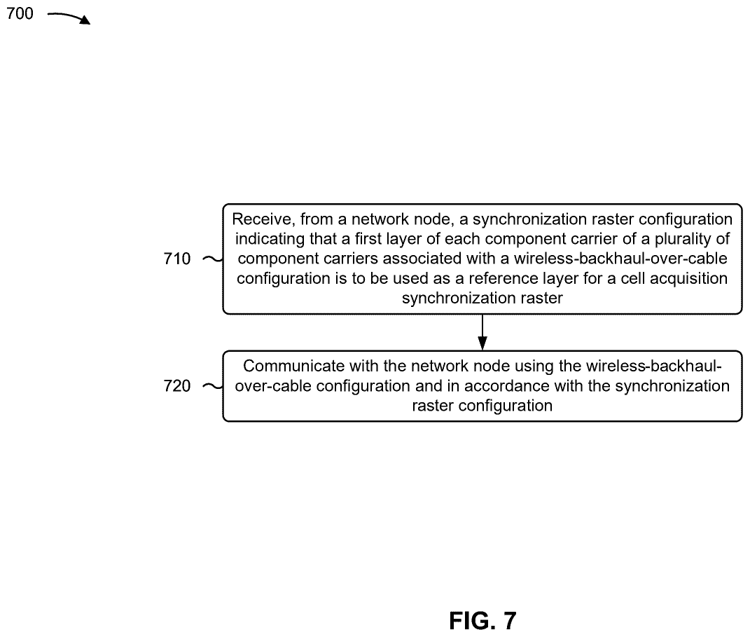

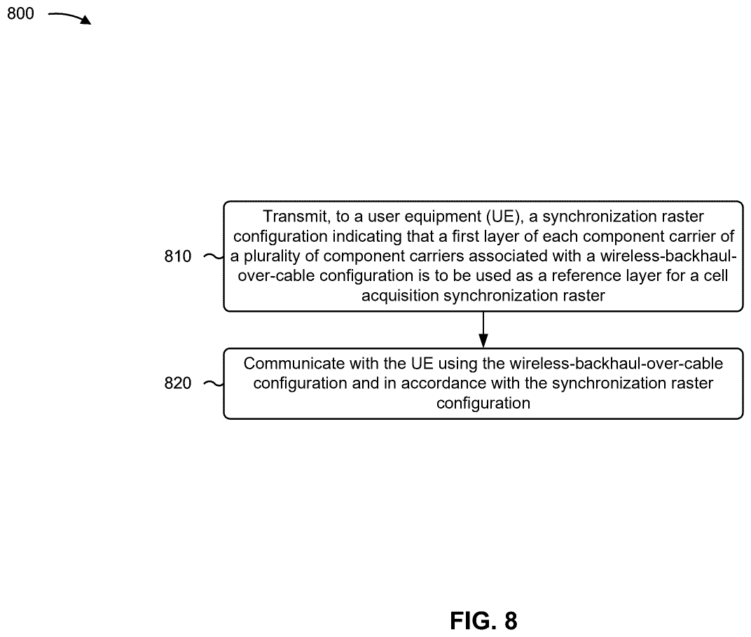

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with synchronization raster configuration, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, the UE 120 includes means for receiving, from a network node, a synchronization raster configuration indicating that a first layer of each component carrier of a plurality of component carriers associated with a wireless-backhaul-over-cable configuration is to be used as a reference layer for a cell acquisition synchronization raster; and/or means for communicating with the network node using the wireless-backhaul-over-cable configuration and in accordance with the synchronization raster configuration. The means for the UE 120 to perform operations described herein may include, for example, one or more of communication manager 150, processing system 140, a radio, one or more RF chains, one or more transceivers, one or more antennas, one or more modems, a reception component, and/or a transmission component, among other examples.

In some aspects, the network node 110 includes means for transmitting, to a UE, a synchronization raster configuration indicating that a first layer of each component carrier of a plurality of component carriers associated with a wireless-backhaul-over-cable configuration is to be used as a reference layer for a cell acquisition synchronization raster; and/or means for communicating with the UE using the wireless-backhaul-over-cable configuration and in accordance with the synchronization raster configuration. The means for the network node 110 to perform operations described herein may include, for example, one or more of communication manager 155, processing system 145, a radio, one or more RF chains, one or more transceivers, one or more antennas, one or more modems, a reception component, and/or a transmission component, among other examples.

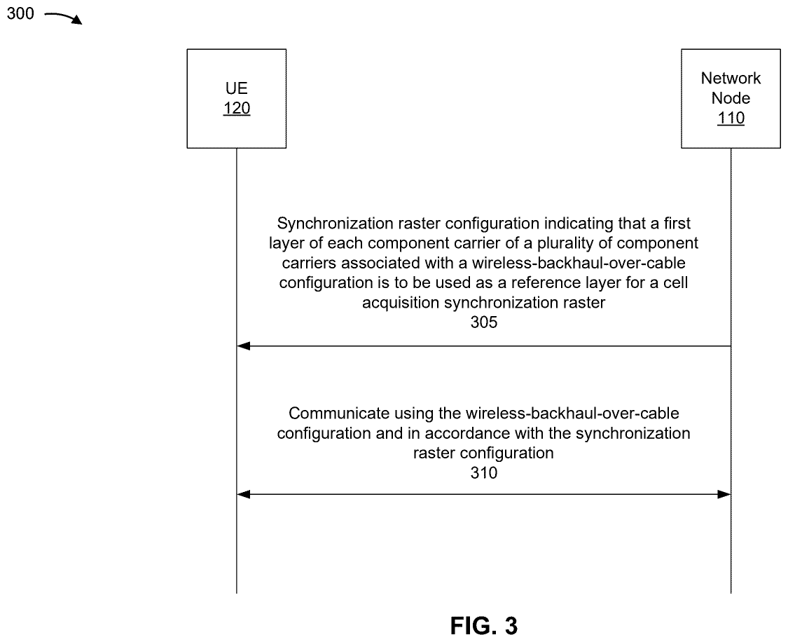

FIG. 3 is a diagram illustrating an example 300 of synchronization raster configuration, in accordance with the present disclosure.

As shown by reference number 305, the network node 110 may transmit, and the UE 120 may receive, a synchronization raster configuration indicating that a first layer of each component carrier of a plurality of component carriers associated with a wireless-backhaul-over-cable configuration is to be used as a reference layer for a cell acquisition synchronization raster. The wireless-backhaul-over-cable configuration may be a wireless-backhaul-over-coax configuration. In some aspects, the wireless-backhaul-over-cable configuration is an NRoC configuration for providing 5G NR data services over a cable infrastructure.

In some aspects, for example, to preserve compatibility with existing software flows for wireless communications, multiple bands may be configured for NRoC communications. The NROC bands may use similar settings as nominal C-bands for wireless carriers and may indicate a translation of signal-on-coax to signal-on-modem. A dedicated set of synchronization rasters having global synchronization channel numbers (GSCN) may be used for NRoC communications between the UE 120 and the network node 110. The first layer of each component carrier for the NROC communications may be used as a reference point for the cell acquisition synchronization rasters. The signal-to-noise ratio (SNR) of the first layer (L0) of each component carrier may be sufficient such that a single port can be used for cell acquisition. Therefore, the UE 120 may not receive other ports (such as L1, L2, L3) for cell acquisition purposes. All SSBs for cell acquisition may be transmitted on L0, although different precoding may be used for the SSBs for NRoC.

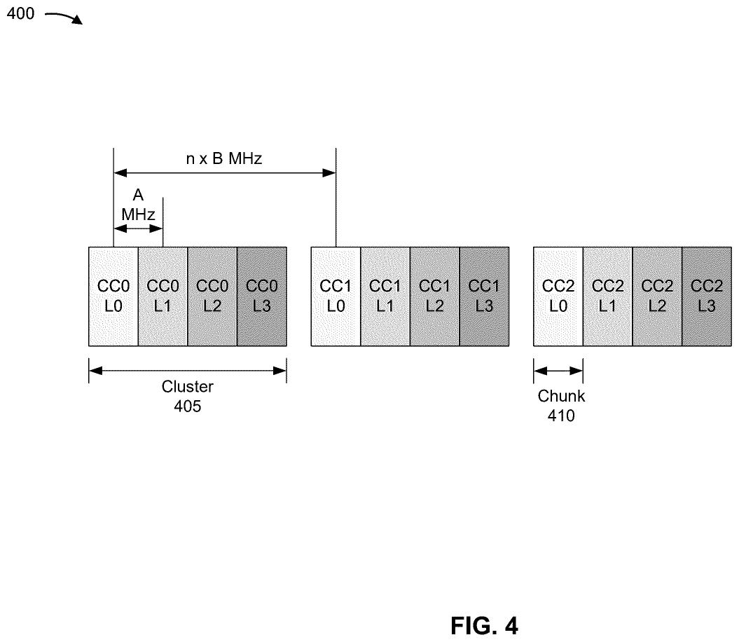

In some aspects, a frequency-domain resource allocation for the cell acquisition synchronization rasters may be in accordance with a clustering scheme. Each chunk in the frequency domain resource allocation may be associated with a certain frequency or frequency range, such as 100 MHz. Two variables, such as A and B, may be indicated, where A and B are close to 100 MHz and where B is slightly larger than A. Within each cluster, the chunks may be spaced A MHz apart, and an offset between each cluster may be nB MHz, where n is the quantity of chunks within each cluster. This may enable the SSB on the first layer (L0) of each component carrier to fall on the synchronization rasters and may prevent SSBs on other layers from falling on the synchronization rasters. Additional details regarding these features are described in connection with FIG. 4.

In one example, N synchronization rasters may be spaced approximately every 100 MHz, for example, to provide flexibility for the network node 110 to configure the channel and the SSBs. A set of parameters for cell acquisition with N=4 and a synchronization raster spacing of approximately 25 MHz may be defined as follows and in accordance with Table 1, where S₁ and S₂ indicate a spacing between potential raster points:

$$\begin{matrix}{S}_{1} = floor ( 100 , 000 / 300 / N ) * 300 kHz \\ {S}_{2} = {S}_{1} + 300 kHz \\ A = N \times {S}_{1} , and B = N \times {S}_{2} .\end{matrix}$$

TABLE 1

| N | S₁ | S₂ | A | B |
|---|---|---|---|---|
| 1 | 99.9 MHz | 100.2 MHz | 99.9 MHz | 100.2 MHz |
| 2 | 49.8 MHz | 50.1 MHz | 99.6 MHz | 100.2 MHz |
| 3 | 33.3 MHz | 33.6 MHz | 99.9 MHz | 100.8 MHz |
| 4 | 24.9 MHz | 35.2 MHz | 99.6 MHz | 100.8 MHz |
| 5 | 19.8 MHz | 20.1 MHz | 99.0 MHz | 100.5 MHz |
| 6 | 16.5 MHz | 16.8 MHz | 99.0 MHz | 100.8 MHz |

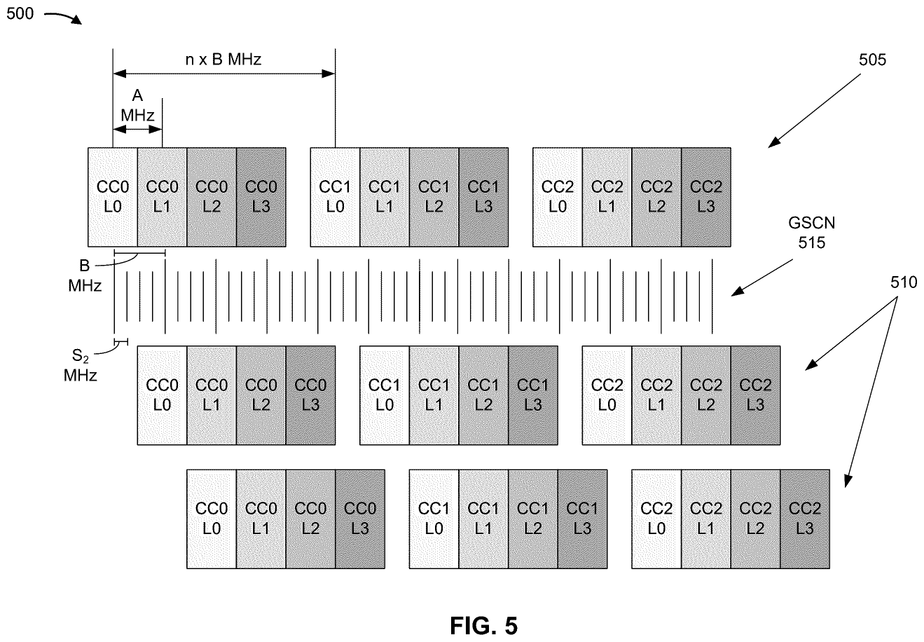

In some aspects, the synchronization raster configuration includes a component-carrier-first mapping. The component-carrier-first mapping may indicate that the layers of each component carrier are to be continuous in a single cluster and that different clusters are to be used for different component carriers. Additional details regarding the component-carrier-first mapping are described in connection with FIG. 5. In one example, each component carrier includes fours layers, the GSCNs are defined with a spacing of 25.2 MHz, and the layers of each CC are separated by 99.6 MHz within a cluster. Therefore, when L0 of the CC falls on a single GSCN, the other layers are offset from the GSCN points by 1200 kHz, 2400 kHz, and 3600 kHz, respectively, with the result that cell acquisition can only pass on L0 of a CC. Additionally, the L0 of the other component carriers falls on the GSCN point. With a GSCN granularity of 25.2 MHz, the network node 110 may have some level of flexibility to adjust the allocation in the frequency domain.

In some aspects, the component-carrier-first mapping may indicate that the layers within each component carrier are to be ordered in a sequential order. For example, the layers may be ordered L0, L1, L2, and L3 within each component carrier. In some other aspects, the component-carrier-first mapping may indicate that the layers within each component carrier are to be ordered in a reverse sequential order. For example, the layers may be ordered L3, L2, L1, and L0 within each component carrier.

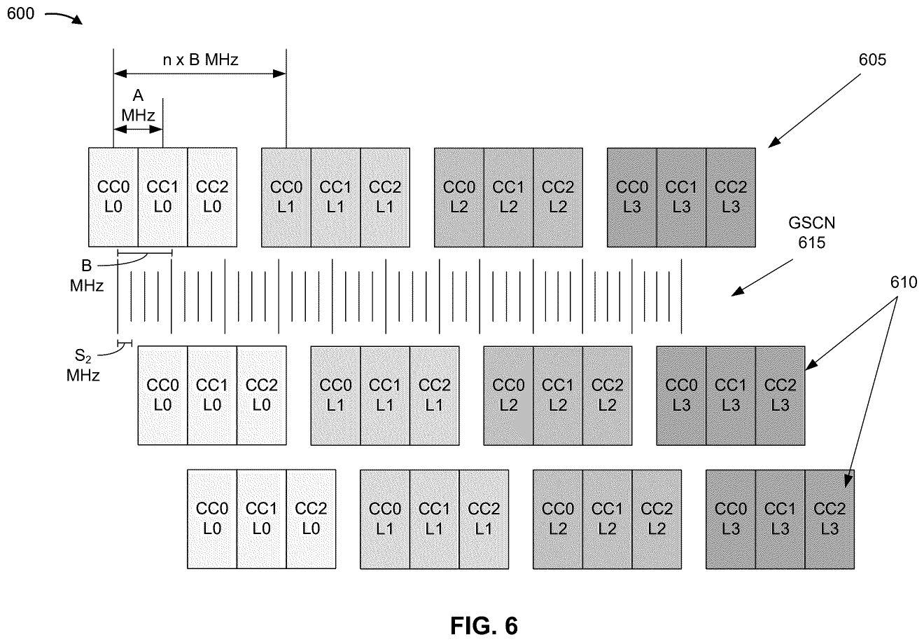

In some aspects, the synchronization raster configuration includes a layer-first mapping. The layer-first mapping may indicate that each cluster is to include the same layer belonging to different component carriers and that each cluster is to be associated with a certain layer. Additional details regarding the component-carrier-first mapping are described in connection with FIG. 6. Similar to the component-carrier-first mapping, the L0 of the other component carriers falls on the GSCN point. With a GSCN granularity of 24.9 MHz, the network node 110 may have some level of flexibility to adjust the allocation in the frequency domain.

In some aspects, the layer-first mapping may be in a sequential order. For example, the first layer (L0) of each component carrier is mapped to the left most portion of the allocated spectrum, followed by the second layer (L1) of each component carrier, the third layer (L2) of each component carrier, and, finally, the fourth layer (L3) of each component carrier. In some other aspects, the layer-first mapping may be in a reverse sequential order. For example, the fourth layer (L3) of each component carrier is mapped to the left most of the allocated spectrum, followed by the third layer (L2) of each component carrier, the second layer (L1) of each component carrier, and, finally, the first layer (L0) of each component carrier.

In some aspects, different synchronization rasters may be assigned to different center frequencies. For example, a component-carrier-first synchronization raster may be assigned to one center frequency and a layer-first synchronization raster may be assigned to another center frequency. Additionally, or alternatively, a sequentially-ordered synchronization raster may be assigned to one center frequency and a reverse-sequentially-ordered synchronization raster may be assigned to another center frequency. In one example, the component-carrier-first synchronization raster and the layer-first synchronization raster may be offset from each other by a certain frequency, such as 150 kHz. Therefore, the minimum distance between the two sets of synchronization rasters may be the certain frequency (150 kHz). Additionally, the GSCN of the sequentially-ordered component-carrier-first synchronization raster and the GSCN of the reverse-sequentially-ordered component-carrier-first synchronization raster may be offset from each other by another certain frequency (such as 300 kHz), and the GSCN of the sequentially-ordered layer-first synchronization raster and the GSCN of the reverse-sequentially-ordered layer-first synchronization raster may be offset from each other by the other certain frequency (such as 300 kHz). Therefore, the synchronization rasters may be distinguishable by their different GSCN numbers. For a given GSCN number, the UE 120 may be configured to determine whether component-carrier-first or layer-first mapping is used, and whether the layer ordering is sequential or reverse-sequential, and may initiate processing accordingly.

In some aspects, the UE 120 (for example, a consumer premises equipment (CPE) device) may be provisioned for one or more NRoC deployment options that are selectively deployed in a network. Allowing the UE 120 to auto-detect the deployment using the configurations above may allow for internet service providers and operators to eliminate the need for explicitly provisioning the UE 120 with a specific band configuration. For example, allowing the UE 120 to have mixed deployments where an initial set of network nodes 110 support a layer-first mapping while subsequent network nodes support component-carrier-first mapping, which may be advantageous but may be more difficult to implement.

In some aspects, an external mixer may result in a spectrally inverted waveform on a cable. Similar to the idea to distinguish component-carrier first or layer-first, and/or to distinguish the order of the layers, by definition different sets of synchronization rasters, another different set of raster grids can be defined to indicate whether an NROC signal is spectrally inverted or not. Therefore, the UE 120 (for example, an NRoC CPE) can process the signal accordingly, such as by reversing the undo the spectral inversion.

As shown by reference number 310, the UE 120 and the network node 110 may communicate using the wireless-backhaul-over-cable configuration and in accordance with the synchronization raster configuration. For example, the UE 120 may perform a cell acquisition process using the synchronization rasters in accordance with the synchronization raster configuration.

As indicated above, FIG. 3 is provided as an example. Other examples may differ from what is described with regard to FIG. 3.

FIG. 4 is a diagram illustrating an example 400 of spectrum allocation for synchronization raster configurations, in accordance with the present disclosure. As described herein, a frequency-domain resource allocation for the cell acquisition synchronization rasters may be in accordance with a clustering scheme. The clustering scheme may include multiple clusters 405, each cluster 405 including multiple chunks 410. Each chunk 410 may be associated with a certain frequency or frequency range, such as 100 MHz. Two variables, such as A and B, may be indicated, where B is slightly larger than A. Within each cluster 405, the chunks 410 may be spaced A MHz apart, and an offset between each cluster 405 may be nB MHz, where n is the quantity of chunks 410 within each cluster 405. This may enable the SSB on the first layer (L0) of each component carrier to fall on the synchronization rasters and may prevent SSBs on other layers from falling on the synchronization rasters.

As indicated above, FIG. 4 is provided as an example. Other examples may differ from what is described with regard to FIG. 4.

FIG. 5 is a diagram illustrating an example 500 of a synchronization raster configuration using component-carrier-first mapping, in accordance with the present disclosure. As described herein, a component-carrier-first mapping may indicate that the layers of each component carrier are to be continuous in a single cluster and that different clusters are to be used for different component carriers. In a first deployment 505 and in alternate deployments 510, a first cluster may associated with a first component carrier CC0, a second cluster may be associated with a second component carrier CC1, a third cluster may be associated with a third component carrier CC2, and a fourth cluster may be associated with a fourth component carrier CC3. The L0 of each component carrier falls on a GSCN point 515, whereas the other layers of each component carrier do not fall on a GSCN point 515. In some aspects, the component-carrier-first mapping may indicate that the layers within each component carrier are to be ordered in a sequential order. For example, the layers may be ordered L0, L1, L2, and L3 within each component carrier. In some other aspects, the component-carrier-first mapping may indicate that the layers within each component carrier are to be ordered in a reverse sequential order. For example, the layers may be ordered L3, L2, L1, and L0 within each component carrier.

As indicated above, FIG. 5 is provided as an example. Other examples may differ from what is described with regard to FIG. 5.

FIG. 6 is a diagram illustrating an example 600 of a synchronization raster configuration using layer-first mapping, in accordance with the present disclosure. As described herein, a layer-first mapping may indicate that each cluster is to include the same layer belonging to different component carriers and that each cluster is to be associated with a certain layer. In a first deployment 605 and in alternate deployments 610, a first cluster may include the first layer (L0) for each component carrier CC0, CC1, and CC2, a second cluster may include the second layer (L1) for each component carrier CC0, CC1, and CC2, a third cluster may include the third layer (L2) for each component carrier CC0, CC1, and CC2, and a fourth cluster may include the fourth layer (L3) for each component carrier CC0, CC1, and CC2. The L0 of each component carrier falls on a GSCN point 615, whereas the other layers of each component carrier do not fall on a GSCN point 615. In some aspects, the layer-first mapping may be in a sequential order. For example, the first layer (L0) of each component carrier is mapped to the left most portion of the allocated spectrum, followed by the second layer (L1) of each component carrier, the third layer (L2) of each component carrier, and, finally, the fourth layer (L3) of each component carrier. In some other aspects, the layer-first mapping may be in a reverse sequential order. For example, the fourth layer (L3) of each component carrier is mapped to the left most of the allocated spectrum, followed by the third layer (L2) of each component carrier, the second layer (L1) of each component carrier, and, finally, the first layer (L0) of each component carrier.

As indicated above, FIG. 6 is provided as an example. Other examples may differ from what is described with regard to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with synchronization raster configuration.

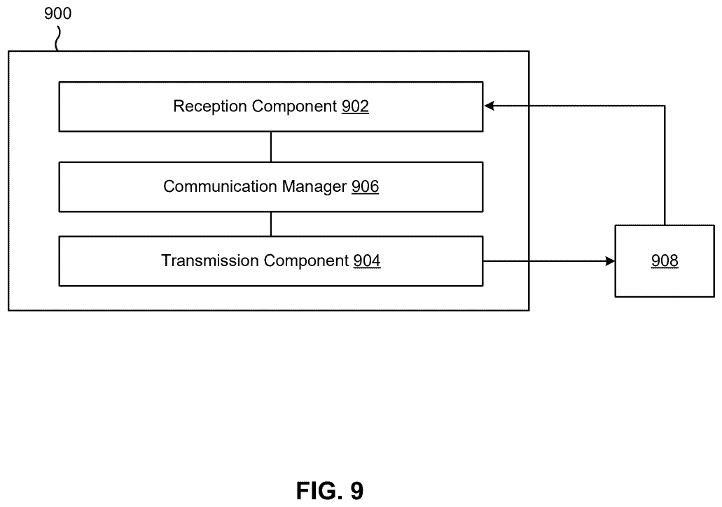

As shown in FIG. 7, in some aspects, process 700 may include receiving, from a network node, a synchronization raster configuration indicating that a first layer of each component carrier of a plurality of component carriers associated with a wireless-backhaul-over-cable configuration is to be used as a reference layer for a cell acquisition synchronization raster (block 710). For example, the UE (e.g., using reception component 902 and/or communication manager 906, depicted in FIG. 9) may receive, from a network node, a synchronization raster configuration indicating that a first layer of each component carrier of a plurality of component carriers associated with a wireless-backhaul-over-cable configuration is to be used as a reference layer for a cell acquisition synchronization raster, as described above.

As further shown in FIG. 7, in some aspects, process 700 may include communicating with the network node using the wireless-backhaul-over-cable configuration and in accordance with the synchronization raster configuration (block 720). For example, the UE (e.g., using reception component 902, transmission component 904, and/or communication manager 906, depicted in FIG. 9) may communicate with the network node using the wireless-backhaul-over-cable configuration and in accordance with the synchronization raster configuration, as described above.

Process 700 may include additional aspects, such as any single aspect or any combination of aspects described below and/or in connection with one or more other processes described elsewhere herein.

In a first aspect, the wireless-backhaul-over-cable configuration is an NRoC configuration.

In a second aspect, alone or in combination with the first aspect, communicating with the network node in accordance with the synchronization raster configuration comprises performing a cell acquisition process using the first layer of each component carrier of the plurality of component carriers associated with the wireless-backhaul-over-cable configuration.

In a third aspect, alone or in combination with one or more of the first and second aspects, performing the cell acquisition process using the first layer of each component carrier of the plurality of component carriers comprises receiving one or more synchronization signal blocks using the first layer of each component carrier of the plurality of component carriers.

In a fourth aspect, alone or in combination with one or more of the first through third aspects, the synchronization raster configuration includes a clustering scheme for a frequency domain resource allocation associated with a cell acquisition process, wherein the clustering scheme indicates a plurality of clusters, and wherein each cluster of the plurality of clusters includes a plurality of chunks.

In a fifth aspect, alone or in combination with one or more of the first through fourth aspects, the plurality of chunks are spaced apart in accordance with a first value and the plurality of clusters are spaced apart in accordance with a second value that is larger than the first value.

In a sixth aspect, alone or in combination with one or more of the first through fifth aspects, an offset associated with the plurality of clusters is based at least in part on a product of the second value and a quantity of chunks within each cluster of the plurality of clusters.

In a seventh aspect, alone or in combination with one or more of the first through sixth aspects, a synchronization signal block for the cell acquisition process is received within the first layer of each component carrier of the plurality of component carriers and is not received within any other layer of each component carrier of the plurality of component carriers.

In an eighth aspect, alone or in combination with one or more of the first through seventh aspects, the synchronization raster configuration includes a component-carrier-based mapping indicating that each cluster of the plurality of clusters includes a different component carrier of the plurality of component carriers and that a plurality of layers associated with each component carrier of the plurality of component carriers are arranged contiguously in each cluster of the plurality of clusters.

In a ninth aspect, alone or in combination with one or more of the first through eighth aspects, the first layer of each component carrier of the plurality of component carriers falls on a global synchronization channel number associated with the cell acquisition synchronization raster.

In a tenth aspect, alone or in combination with one or more of the first through ninth aspects, the first layer of each component carrier of the plurality of component carriers is included in a first chunk of a corresponding cluster associated with the component carrier.

In an eleventh aspect, alone or in combination with one or more of the first through tenth aspects, the first layer of each component carrier of the plurality of component carriers is included in a last chunk of a corresponding cluster associated with the component carrier.

In a twelfth aspect, alone or in combination with one or more of the first through eleventh aspects, the synchronization raster configuration includes a layer-based mapping indicating that each cluster of the plurality of clusters includes a same layer of a plurality of layers associated with the plurality of component carriers and that the plurality of component carriers are arranged contiguously in each cluster of the plurality of clusters.

In a thirteenth aspect, alone or in combination with one or more of the first through twelfth aspects, the first layer of each component carrier of the plurality of component carriers falls on a global synchronization channel number associated with the cell acquisition synchronization raster.

In a fourteenth aspect, alone or in combination with one or more of the first through thirteenth aspects, the first layer of each component carrier of the plurality of component carriers is included in a first cluster of the plurality of clusters.

In a fifteenth aspect, alone or in combination with one or more of the first through fourteenth aspects, the first layer of each component carrier of the plurality of component carriers is included in a last cluster of the plurality of clusters.

In a sixteenth aspect, alone or in combination with one or more of the first through fifteenth aspects, a first synchronization raster associated with a component-carrier-based mapping is assigned to a first center frequency and a second synchronization raster associated with a layer-based mapping is assigned to a second center frequency.

In a seventeenth aspect, alone or in combination with one or more of the first through sixteenth aspects, a first global synchronization channel number indicates that the first synchronization raster is to be used as the reference layer and a second global synchronization channel number indicates that the second synchronization raster is to be used as the reference layer.

In an eighteenth aspect, alone or in combination with one or more of the first through seventeenth aspects, a first global synchronization channel number indicates that a standard ordering for a plurality of layers or the plurality of component carriers is to be used as the reference layer and a second global synchronization channel number indicates that a reverse ordering for a plurality of layers or the plurality of component carriers is to be used as the reference layer.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with synchronization raster configuration.

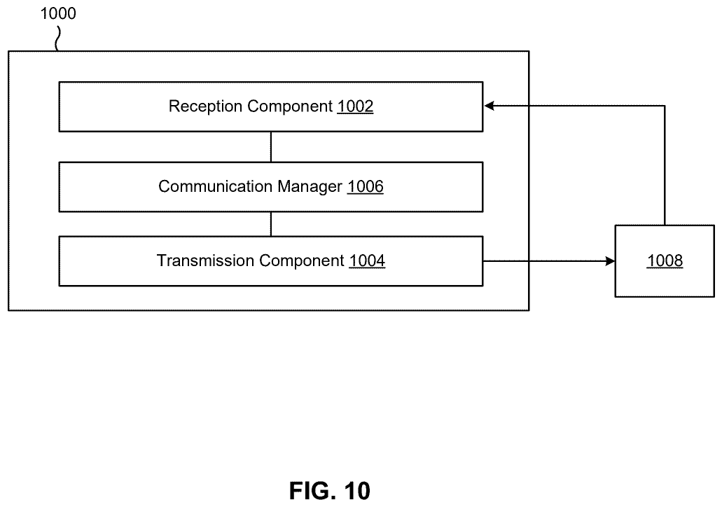

As shown in FIG. 8, in some aspects, process 800 may include transmitting, to a UE, a synchronization raster configuration indicating that a first layer of each component carrier of a plurality of component carriers associated with a wireless-backhaul-over-cable configuration is to be used as a reference layer for a cell acquisition synchronization raster (block 810). For example, the network node (e.g., using transmission component 1004 and/or communication manager 1006, depicted in FIG. 10) may transmit, to a UE, a synchronization raster configuration indicating that a first layer of each component carrier of a plurality of component carriers associated with a wireless-backhaul-over-cable configuration is to be used as a reference layer for a cell acquisition synchronization raster, as described above.

As further shown in FIG. 8, in some aspects, process 800 may include communicating with the UE using the wireless-backhaul-over-cable configuration and in accordance with the synchronization raster configuration (block 820). For example, the network node (e.g., using reception component 1002, transmission component 1004, and/or communication manager 1006, depicted in FIG. 10) may communicate with the UE using the wireless-backhaul-over-cable configuration and in accordance with the synchronization raster configuration, as described above.

Process 800 may include additional aspects, such as any single aspect or any combination of aspects described below and/or in connection with one or more other processes described elsewhere herein.

In a first aspect, the wireless-backhaul-over-cable configuration is an NROC configuration.

In a second aspect, alone or in combination with the first aspect, communicating with the UE in accordance with the synchronization raster configuration comprises performing a cell acquisition process using the first layer of each component carrier of the plurality of component carriers associated with the wireless-backhaul-over-cable configuration.

In a third aspect, alone or in combination with one or more of the first and second aspects, performing the cell acquisition process using the first layer of each component carrier of the plurality of component carriers comprises transmitting one or more synchronization signal blocks using the first layer of each component carrier of the plurality of component carriers.

In a fourth aspect, alone or in combination with one or more of the first through third aspects, the synchronization raster configuration includes a clustering scheme for a frequency domain resource allocation associated with a cell acquisition process, wherein the clustering scheme indicates a plurality of clusters, and wherein each cluster of the plurality of clusters includes a plurality of chunks.

In a fifth aspect, alone or in combination with one or more of the first through fourth aspects, the plurality of chunks are spaced apart in accordance with a first value and the plurality of clusters are spaced apart in accordance with a second value that is larger than the first value.

In a sixth aspect, alone or in combination with one or more of the first through fifth aspects, an offset associated with the plurality of clusters is based at least in part on a product of the second value and a quantity of chunks within each cluster of the plurality of clusters.

In a seventh aspect, alone or in combination with one or more of the first through sixth aspects, a synchronization signal block for the cell acquisition process is transmitted within the first layer of each component carrier of the plurality of component carriers and is not transmitted within any other layer of each component carrier of the plurality of component carriers.

In an eighth aspect, alone or in combination with one or more of the first through seventh aspects, the synchronization raster configuration includes a component-carrier-based mapping indicating that each cluster of the plurality of clusters includes a different component carrier of the plurality of component carriers and that a plurality of layers associated with each component carrier of the plurality of component carriers are arranged contiguously in each cluster of the plurality of clusters.

In a ninth aspect, alone or in combination with one or more of the first through eighth aspects, the first layer of each component carrier of the plurality of component carriers falls on a global synchronization channel number associated with the cell acquisition synchronization raster.

In a tenth aspect, alone or in combination with one or more of the first through ninth aspects, the first layer of each component carrier of the plurality of component carriers is included in a first chunk of a corresponding cluster associated with the component carrier.

In an eleventh aspect, alone or in combination with one or more of the first through tenth aspects, the first layer of each component carrier of the plurality of component carriers is included in a last chunk of a corresponding cluster associated with the component carrier.

In a twelfth aspect, alone or in combination with one or more of the first through eleventh aspects, the synchronization raster configuration includes a layer-based mapping indicating that each cluster of the plurality of clusters includes a same layer of a plurality of layers associated with the plurality of component carriers and that the plurality of component carriers are arranged contiguously in each cluster of the plurality of clusters.

In a thirteenth aspect, alone or in combination with one or more of the first through twelfth aspects, the first layer of each component carrier of the plurality of component carriers falls on a global synchronization channel number associated with the cell acquisition synchronization raster.

In a fourteenth aspect, alone or in combination with one or more of the first through thirteenth aspects, the first layer of each component carrier of the plurality of component carriers is included in a first cluster of the plurality of clusters.

In a fifteenth aspect, alone or in combination with one or more of the first through fourteenth aspects, the first layer of each component carrier of the plurality of component carriers is included in a last cluster of the plurality of clusters.

In a sixteenth aspect, alone or in combination with one or more of the first through fifteenth aspects, a first synchronization raster associated with a component-carrier-based mapping is assigned to a first center frequency and a second synchronization raster associated with a layer-based mapping is assigned to a second center frequency.

In a seventeenth aspect, alone or in combination with one or more of the first through sixteenth aspects, a first global synchronization channel number indicates that the first synchronization raster is to be used as the reference layer and a second global synchronization channel number indicates that the second synchronization raster is to be used as the reference layer.

In an eighteenth aspect, alone or in combination with one or more of the first through seventeenth aspects, a first global synchronization channel number indicates that a standard ordering for a plurality of layers or the plurality of component carriers is to be used as the reference layer and a second global synchronization channel number indicates that a reverse ordering for a plurality of layers or the plurality of component carriers is to be used as the reference layer.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a network node, a synchronization raster configuration indicating that a first layer of each component carrier of a plurality of component carriers associated with a wireless-backhaul-over-cable configuration is to be used as a reference layer for a cell acquisition synchronization raster. The reception component 902 and/or the transmission component 904 may communicate with the network node using the wireless-backhaul-over-cable configuration and in accordance with the synchronization raster configuration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a UE, a synchronization raster configuration indicating that a first layer of each component carrier of a plurality of component carriers associated with a wireless-backhaul-over-cable configuration is to be used as a reference layer for a cell acquisition synchronization raster. The reception component 1002 and/or the transmission component 1004 may communicate with the UE using the wireless-backhaul-over-cable configuration and in accordance with the synchronization raster configuration.

The number and arrangement of components shown in FIG. 10 are provided as an example. In practice, there may be additional components, fewer components, different components, or differently arranged components than those shown in FIG. 10.

Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: receiving, from a network node, a synchronization raster configuration indicating that a first layer of each component carrier of a plurality of component carriers associated with a wireless-backhaul-over-cable configuration is to be used as a reference layer for a cell acquisition synchronization raster; and communicating with the network node using the wireless-backhaul-over-cable configuration and in accordance with the synchronization raster configuration.
Aspect 2: The method of Aspect 1, wherein the wireless-backhaul-over-cable configuration is a New Radio over coax (NRoC) configuration.
Aspect 3: The method of any of Aspects 1-2, wherein communicating with the network node in accordance with the synchronization raster configuration comprises performing a cell acquisition process using the first layer of each component carrier of the plurality of component carriers associated with the wireless-backhaul-over-cable configuration.
Aspect 4: The method of Aspect 3, wherein performing the cell acquisition process using the first layer of each component carrier of the plurality of component carriers comprises receiving one or more synchronization signal blocks using the first layer of each component carrier of the plurality of component carriers.
Aspect 5: The method of any of Aspects 1-4, wherein the synchronization raster configuration includes a clustering scheme for a frequency domain resource allocation associated with a cell acquisition process, wherein the clustering scheme indicates a plurality of clusters, and wherein each cluster of the plurality of clusters includes a plurality of chunks.
Aspect 6: The method of Aspect 5, wherein the plurality of chunks are spaced apart in accordance with a first value and the plurality of clusters are spaced apart in accordance with a second value that is larger than the first value.
Aspect 7: The method of Aspect 6, wherein an offset associated with the plurality of clusters is based at least in part on a product of the second value and a quantity of chunks within each cluster of the plurality of clusters.
Aspect 8: The method of Aspect 5, wherein a synchronization signal block for the cell acquisition process is received within the first layer of each component carrier of the plurality of component carriers and is not received within any other layer of each component carrier of the plurality of component carriers.
Aspect 9: The method of Aspect 5, wherein the synchronization raster configuration includes a component-carrier-based mapping indicating that each cluster of the plurality of clusters includes a different component carrier of the plurality of component carriers and that a plurality of layers associated with each component carrier of the plurality of component carriers are arranged contiguously in each cluster of the plurality of clusters.
Aspect 10: The method of Aspect 9, wherein the first layer of each component carrier of the plurality of component carriers falls on a global synchronization channel number associated with the cell acquisition synchronization raster.
Aspect 11: The method of Aspect 9, wherein the first layer of each component carrier of the plurality of component carriers is included in a first chunk of a corresponding cluster associated with the component carrier.
Aspect 12: The method of Aspect 9, wherein the first layer of each component carrier of the plurality of component carriers is included in a last chunk of a corresponding cluster associated with the component carrier.
Aspect 13: The method of Aspect 5, wherein the synchronization raster configuration includes a layer-based mapping indicating that each cluster of the plurality of clusters includes a same layer of a plurality of layers associated with the plurality of component carriers and that the plurality of component carriers are arranged contiguously in each cluster of the plurality of clusters.
Aspect 14: The method of Aspect 13, wherein the first layer of each component carrier of the plurality of component carriers falls on a global synchronization channel number associated with the cell acquisition synchronization raster.
Aspect 15: The method of Aspect 13, wherein the first layer of each component carrier of the plurality of component carriers is included in a first cluster of the plurality of clusters.
Aspect 16: The method of Aspect 13, wherein the first layer of each component carrier of the plurality of component carriers is included in a last cluster of the plurality of clusters.
Aspect 17: The method of any of Aspects 1-16, wherein a first synchronization raster associated with a component-carrier-based mapping is assigned to a first center frequency and a second synchronization raster associated with a layer-based mapping is assigned to a second center frequency.
Aspect 18: The method of Aspect 17, wherein a first global synchronization channel number indicates that the first synchronization raster is to be used as the reference layer and a second global synchronization channel number indicates that the second synchronization raster is to be used as the reference layer.
Aspect 19: The method of Aspect 17, wherein a first global synchronization channel number indicates that a standard ordering for a plurality of layers or the plurality of component carriers is to be used as the reference layer and a second global synchronization channel number indicates that a reverse ordering for a plurality of layers or the plurality of component carriers is to be used as the reference layer.
Aspect 20: A method of wireless communication performed by a network node, comprising: transmitting, to a user equipment (UE), a synchronization raster configuration indicating that a first layer of each component carrier of a plurality of component carriers associated with a wireless-backhaul-over-cable configuration is to be used as a reference layer for a cell acquisition synchronization raster; and communicating with the UE using the wireless-backhaul-over-cable configuration and in accordance with the synchronization raster configuration.
Aspect 21: The method of Aspect 20, wherein the wireless-backhaul-over-cable configuration is a New Radio over coax (NRoC) configuration.
Aspect 22: The method of any of Aspects 20-21, wherein communicating with the UE in accordance with the synchronization raster configuration comprises performing a cell acquisition process using the first layer of each component carrier of the plurality of component carriers associated with the wireless-backhaul-over-cable configuration.
Aspect 23: The method of Aspect 22, wherein performing the cell acquisition process using the first layer of each component carrier of the plurality of component carriers comprises transmitting one or more synchronization signal blocks using the first layer of each component carrier of the plurality of component carriers.
Aspect 24: The method of any of Aspects 20-23, wherein the synchronization raster configuration includes a clustering scheme for a frequency domain resource allocation associated with a cell acquisition process, wherein the clustering scheme indicates a plurality of clusters, and wherein each cluster of the plurality of clusters includes a plurality of chunks.
Aspect 25: The method of Aspect 24, wherein the plurality of chunks are spaced apart in accordance with a first value and the plurality of clusters are spaced apart in accordance with a second value that is larger than the first value.
Aspect 26: The method of Aspect 25, wherein an offset associated with the plurality of clusters is based at least in part on a product of the second value and a quantity of chunks within each cluster of the plurality of clusters.
Aspect 27: The method of Aspect 24, wherein a synchronization signal block for the cell acquisition process is transmitted within the first layer of each component carrier of the plurality of component carriers and is not transmitted within any other layer of each component carrier of the plurality of component carriers.
Aspect 28: The method of Aspect 24, wherein the synchronization raster configuration includes a component-carrier-based mapping indicating that each cluster of the plurality of clusters includes a different component carrier of the plurality of component carriers and that a plurality of layers associated with each component carrier of the plurality of component carriers are arranged contiguously in each cluster of the plurality of clusters.
Aspect 29: The method of Aspect 28, wherein the first layer of each component carrier of the plurality of component carriers falls on a global synchronization channel number associated with the cell acquisition synchronization raster.
Aspect 30: The method of Aspect 28, wherein the first layer of each component carrier of the plurality of component carriers is included in a first chunk of a corresponding cluster associated with the component carrier.
Aspect 31: The method of Aspect 28, wherein the first layer of each component carrier of the plurality of component carriers is included in a last chunk of a corresponding cluster associated with the component carrier.
Aspect 32: The method of Aspect 24, wherein the synchronization raster configuration includes a layer-based mapping indicating that each cluster of the plurality of clusters includes a same layer of a plurality of layers associated with the plurality of component carriers and that the plurality of component carriers are arranged contiguously in each cluster of the plurality of clusters.
Aspect 33: The method of Aspect 32, wherein the first layer of each component carrier of the plurality of component carriers falls on a global synchronization channel number associated with the cell acquisition synchronization raster.
Aspect 34: The method of Aspect 32, wherein the first layer of each component carrier of the plurality of component carriers is included in a first cluster of the plurality of clusters.
Aspect 35: The method of Aspect 32, wherein the first layer of each component carrier of the plurality of component carriers is included in a last cluster of the plurality of clusters.
Aspect 36: The method of any of Aspects 20-35, wherein a first synchronization raster associated with a component-carrier-based mapping is assigned to a first center frequency and a second synchronization raster associated with a layer-based mapping is assigned to a second center frequency.
Aspect 37: The method of Aspect 36, wherein a first global synchronization channel number indicates that the first synchronization raster is to be used as the reference layer and a second global synchronization channel number indicates that the second synchronization raster is to be used as the reference layer.
Aspect 38: The method of Aspect 36, wherein a first global synchronization channel number indicates that a standard ordering for a plurality of layers or the plurality of component carriers is to be used as the reference layer and a second global synchronization channel number indicates that a reverse ordering for a plurality of layers or the plurality of component carriers is to be used as the reference layer.
Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.
Aspect 40: An apparatus for wireless communication at a device, the apparatus comprising one or more memories and one or more processors coupled to the one or more memories, the one or more processors configured to cause the device to perform the method of one or more of Aspects 1-38.
Aspect 41: An apparatus for wireless communication, the apparatus comprising at least one means for performing the method of one or more of Aspects 1-38.
Aspect 42: A non-transitory computer-readable medium storing code for wireless communication, the code comprising instructions executable by one or more processors to perform the method of one or more of Aspects 1-38.
Aspect 43: A non-transitory computer-readable medium storing a set of instructions for wireless communication, the set of instructions comprising one or more instructions that, when executed by one or more processors of a device, cause the device to perform the method of one or more of Aspects 1-38.
Aspect 44: A device for wireless communication, the device comprising a processing system that includes one or more processors and one or more memories coupled with the one or more processors, the processing system configured to cause the device to perform the method of one or more of Aspects 1-38.
Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive, from a network node, a synchronization raster configuration indicating that a first layer of each component carrier of a plurality of component carriers associated with a wireless-backhaul-over-cable configuration is to be used as a reference layer for a cell acquisition synchronization raster; and
communicate with the network node using the wireless-backhaul-over-cable configuration and in accordance with the synchronization raster configuration.

2. The apparatus of claim 1, wherein the wireless-backhaul-over-cable configuration is a New Radio over coax (NRoC) configuration.

3. The apparatus of claim 1, wherein the one or more processors, to cause the UE to communicate with the network node in accordance with the synchronization raster configuration, are configured to cause the UE to perform a cell acquisition process using the first layer of each component carrier of the plurality of component carriers associated with the wireless-backhaul-over-cable configuration.

4. The apparatus of claim 3, wherein the one or more processors, to cause the UE to perform the cell acquisition process using the first layer of each component carrier of the plurality of component carriers, are configured to cause the UE to receive one or more synchronization signal blocks using the first layer of each component carrier of the plurality of component carriers.

5. The apparatus of claim 1, wherein the synchronization raster configuration includes a clustering scheme for a frequency domain resource allocation associated with a cell acquisition process, wherein the clustering scheme indicates a plurality of clusters, and wherein each cluster of the plurality of clusters includes a plurality of chunks.

6. The apparatus of claim 5, wherein the plurality of chunks are spaced apart in accordance with a first value and the plurality of clusters are spaced apart in accordance with a second value that is larger than the first value.

7. The apparatus of claim 6, wherein an offset associated with the plurality of clusters is based at least in part on a product of the second value and a quantity of chunks within each cluster of the plurality of clusters.

8. The apparatus of claim 5, wherein a synchronization signal block for the cell acquisition process is received within the first layer of each component carrier of the plurality of component carriers and is not received within any other layer of each component carrier of the plurality of component carriers.

9. The apparatus of claim 5, wherein the synchronization raster configuration includes a component-carrier-based mapping indicating that each cluster of the plurality of clusters includes a different component carrier of the plurality of component carriers and that a plurality of layers associated with each component carrier of the plurality of component carriers are arranged contiguously in each cluster of the plurality of clusters.

10. The apparatus of claim 9, wherein the first layer of each component carrier of the plurality of component carriers is included in a first chunk of a corresponding cluster associated with the component carrier.

11. The apparatus of claim 9, wherein the first layer of each component carrier of the plurality of component carriers is included in a last chunk of a corresponding cluster associated with the component carrier.

12. The apparatus of claim 5, wherein the synchronization raster configuration includes a layer-based mapping indicating that each cluster of the plurality of clusters includes a same layer of a plurality of layers associated with the plurality of component carriers and that the plurality of component carriers are arranged contiguously in each cluster of the plurality of clusters.

13. The apparatus of claim 12, wherein the first layer of each component carrier of the plurality of component carriers is included in a first cluster of the plurality of clusters.

14. The apparatus of claim 12, wherein the first layer of each component carrier of the plurality of component carriers is included in a last cluster of the plurality of clusters.

15. The apparatus of claim 1, wherein a first synchronization raster associated with a component-carrier-based mapping is assigned to a first center frequency and a second synchronization raster associated with a layer-based mapping is assigned to a second center frequency.

16. The apparatus of claim 15, wherein a first global synchronization channel number indicates that the first synchronization raster is to be used as the reference layer and a second global synchronization channel number indicates that the second synchronization raster is to be used as the reference layer.

17. The apparatus of claim 15, wherein a first global synchronization channel number indicates that a standard ordering for a plurality of layers or the plurality of component carriers is to be used as the reference layer and a second global synchronization channel number indicates that a reverse ordering for a plurality of layers or the plurality of component carriers is to be used as the reference layer.

18. An apparatus for wireless communication at a network node, comprising:
one or more memories; and
one or more processors, coupled to the one or more memories, configured to cause the network node to:
transmit, to a user equipment (UE), a synchronization raster configuration indicating that a first layer of each component carrier of a plurality of component carriers associated with a wireless-backhaul-over-cable configuration is to be used as a reference layer for a cell acquisition synchronization raster; and
communicate with the UE using the wireless-backhaul-over-cable configuration and in accordance with the synchronization raster configuration.

19. The apparatus of claim 18, wherein the one or more processors, to cause the network node to communicate with the UE in accordance with the synchronization raster configuration, are configured to cause the network node to perform a cell acquisition process using the first layer of each component carrier of the plurality of component carriers associated with the wireless-backhaul-over-cable configuration, wherein the wireless-backhaul-over-cable configuration is a New Radio over coax (NRoC) configuration.

20. A method of wireless communication performed by a user equipment (UE), comprising:
receiving, from a network node, a synchronization raster configuration indicating that a first layer of each component carrier of a plurality of component carriers associated with a wireless-backhaul-over-cable configuration is to be used as a reference layer for a cell acquisition synchronization raster; and
communicating with the network node using the wireless-backhaul-over-cable configuration and in accordance with the synchronization raster configuration.
